(19) United States
(12) Patent Application Publication
(10) Pub. No.: US 2018/0017207 A1
(43) Pub. Date: Jan. 18, 2018

(54) SUPPORT STRUCTURE FOR CARRYING STRAP AND CARRYING STRAP FOR DISTRIBUTING LOAD

(71) Applicant: Harald Benz, Toronto (CA)

(72) Inventor: Harald Benz, Toronto (CA)

(21) Appl. No.: 15/646,580

(22) Filed: Jul. 11, 2017

Related U.S. Application Data
(60) Provisional application No. 62/361,610, filed on Jul. 13, 2016.

(51) Int. Cl. F16M 13/04; A45F 3/02; A45F 3/00

(52) U.S. Cl. CPC F16M 13/04; A45F 3/02; A45F 2003/002

(57) ABSTRACT

The present invention is directed to a carrying strap for devices such as cameras, bags and the like which focuses the weight supported by the carrying strap over the underlying major muscles of the neck or shoulder. The carrying strap is provided with support structures releasably attached to the carrying strap to lie over the underlying muscles of the neck or shoulder, the support structures extending below the carrying strap to transfer the weight of the device to the underlying muscles of the neck or shoulder.

### BACKGROUND OF THE INVENTION

The present invention is directed to an apparatus for use with carrying straps, or carrying straps incorporating the apparatus, which are placed over the back of the neck or the shoulder to carry devices such as cameras, bags and the like. In particular, the present invention is directed to an apparatus which focuses the weight supported by the carrying strap in a point fashion over a major muscle group of the back of the neck or the shoulder.

### FIELD OF THE INVENTION

Many devices such as cameras, bags and the like are provided with carrying straps which allow the device to be supported by placing the carrying strap over the shoulder or around the back of the neck. The carrying straps are generally a fabric or leather strap attached at either end to the device. In order to distribute the weight of the device, the carrying strap is generally a wide strap to allow for a larger surface area for distributing weight or if the strap is a narrow strap it may be provided with a wider padded support pad which is generally slidably attached the strap. While such straps distribute the weight of the device over a broader area of the neck or shoulder, it has been found with extended period of use the strap can still result in fatigue and pain of the neck or shoulder from supporting the weight of the device for such extended period of use.

There thus still remains a need for a carrying strap for devices such as cameras, bags and the like which will reduce the fatigue and pain of the neck or shoulder arising from supporting the weight of the device for an extended period of time.

### SUMMARY OF THE INVENTION

The present invention is directed to a carrying strap for devices such as cameras, bags and the like which focuses the weight supported by the carrying strap over the underlying major muscles of the neck or shoulder.

In an aspect of the invention the carrying strap is provided with support structures releasably attached to the carrying strap to lie over the underlying muscles of the neck or shoulder, the support structures extending below the carrying strap to transfer the weight of the device to the underlying muscles of the neck or shoulder.

In another aspect of the invention the support structure is a cylindrical structure releasably attached to the carrying strap in the proper position.

Another aspect of the invention relates to a support system for use with a carrying strap comprising at least two support structures each having an opening for receiving a carrying strap and an engagement mechanism for securing the support structure to a desired location on the carrying strap. In this embodiment, the support structures are spaced from each other along a length of the carrying strap.

In a further aspect of the invention, the support structures are shaped to distribute forces over a small area.

In yet a further aspect of the invention, each support structure is cylindrical in shape.

In yet a further aspect of the invention, each support structure is made of a molded material.

In yet a further aspect of the invention, each support structure further includes a slot around a partial perimeter of the support structure. The slot is in communication with the opening such that a carrying strap could be passed through the slot and into the opening.

In yet a further aspect of the invention, the engagement mechanism is a screw.

In another embodiment of the invention, the support structures are positioned on the carrying strap such that when the strap is in use, the support structures are positioned to correspond to the location of major muscles of the neck.

In a further aspect of the invention, the support structures are positioned on said carrying strap such that when the strap is in use, the support structures are positioned to correspond to the location of the trapezius muscles.

In another embodiment of the invention, the support structures are positioned on said carrying strap such that when the strap is in use, the support structures are positioned over major muscles of the shoulder.

Another aspect of the invention pertains to a carrying apparatus comprising an elongate strap and at least two support structures. Each support structure is coupled to the strap in a spaced apart manner along the length of the strap.

In a further aspect of the invention, the support structures are shaped to distribute forces over a small area.

In a further aspect of the invention, each support structure is cylindrical in shape.

In a further aspect of the invention, each support structure is made of a molded material.

In yet a further aspect of the invention, each support structure has an opening for receiving the elongate strap and an engagement mechanism for securing the support structure to a desired location on said carrying strap.

In yet a further aspect of the invention, each support structure further includes a slot around a partial perimeter of the support structure. The slot is in communication with the opening such that a carrying strap could be passed through the slot and into the opening.

In yet a further aspect of the invention, the engagement mechanism is a screw.

In another aspect of the invention, the support structures are positioned on the carrying strap such that when the strap is in use, the support structures are positioned to correspond to the location of major muscles of the neck.

In a further aspect of the invention, the support structures are positioned on the carrying strap such that when the strap is in use, the support structures are positioned to correspond to the location of the trapezius muscles.

In another aspect of the invention, the support structures are positioned on the carrying strap such that when the strap is in use, the support structures are positioned over major muscles of the shoulder.

### BRIEF DESCRIPTION OF THE DRAWINGS

A preferred embodiment of the present invention is illustrated in the attached drawings in which:

FIG. 1 is a perspective view of the use of the carrying strap of the present invention to support a device around the neck;

FIG. 2 is a perspective view of a preferred embodiment of the carrying strap of the present invention;

FIG. 3 is a perspective view of the cylindrical support structure of the carrying strap of FIG. 2;

FIG. 4 is a perspective view of the disassembled support structure of FIG. 3; and

FIG. 5 illustrates the releasable attachment of the cylindrical support structure to the carrying strap.

### DETAILED DESCRIPTION OF PREFERRED EMBODIMENTS

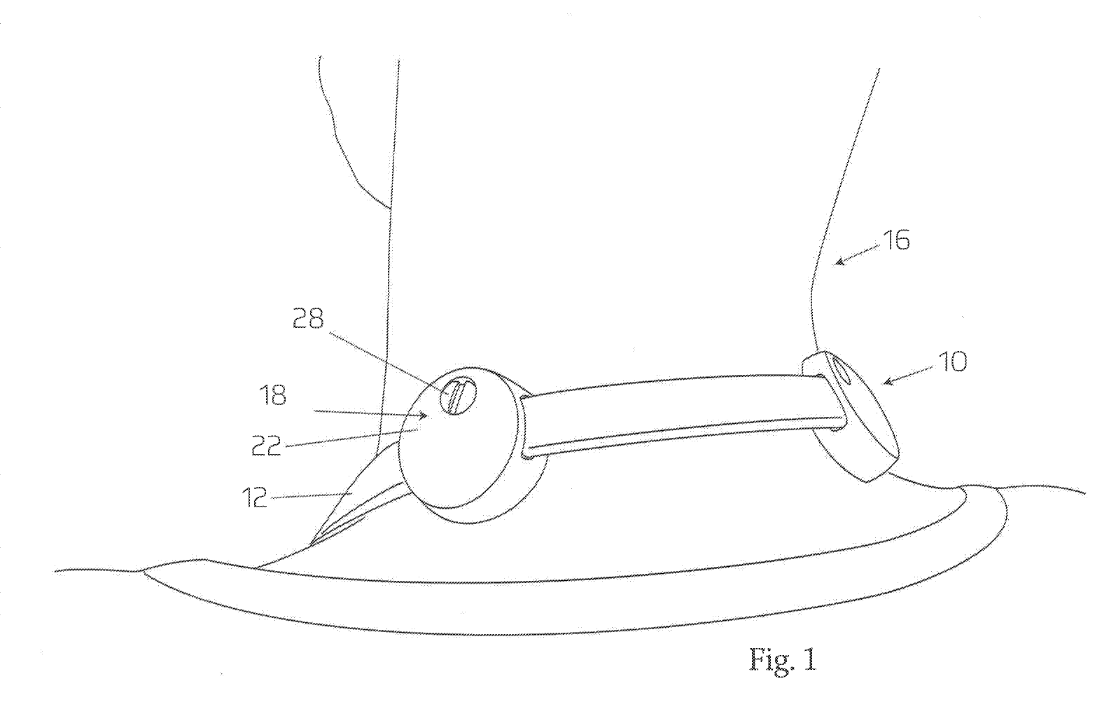

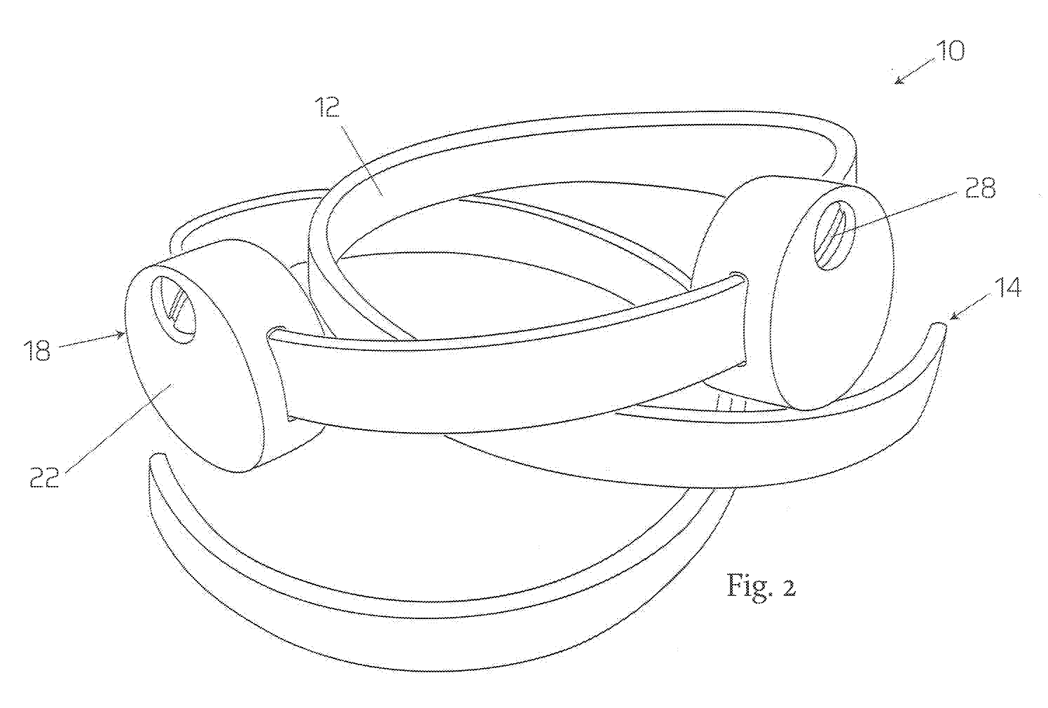

A preferred embodiment of the carrying strap of the present invention is illustrated in the attached drawings generally indicated by the 10. Referring now to FIGS. 1 and 2, carrying strap 10 has a strap 12 having two ends 14 for attaching to the device to be carried by looping the strap over the shoulder or around the neck 16. In the embodiment illustrated in the drawings, strap 12 is a leather strap, however the strap may be any material known in the art for use in carrying straps.

The carrying strap 10 is also provided with support structures 18 which are placed so that they will rest on the major muscles of the neck, in particular the trapezius muscle. The position of the support structures may also generally correspond to acupressure points. In the preferred embodiment shown in the figures, the support structures 18 are cylindrical in shape having generally flat bottom 20 and top 22 surfaces. However, a person skilled in the art will appreciate that other shapes such as ovals or squares or rectangles with curved or angled corners would also be suitable. The Support structures are sized and shaped to focus the weight of the object being carried over a small area which distributes the load in a point-like fashion.

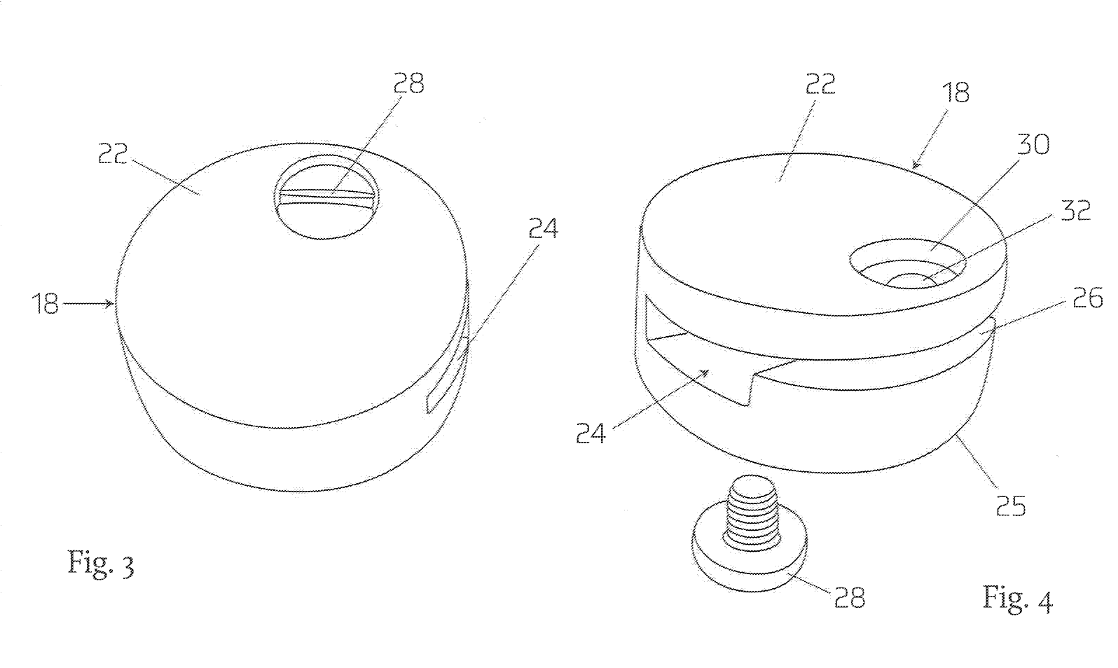

As shown in FIGS. 3 and 4, the slot 24 in the support structure spaced from the bottom surface 25. This spacing is such that when in use, the portion strap 12 between the two support structures is elevated from a user's neck. This preferred embodiment keeps the strap from contacting the bones of the cervical spine to reduce pressure on the vertebra as shown in FIG. 1.

The support structures 18 are preferably constructed of a molded material such as a plastic or rubber. Preferably the support structure is molded from a polymeric plastic such as polypropylene or polyethylene or a rubber material such as ABS or silicone. The support structure may also be manufactured by a 3D printing process. In an alternative embodiment, the support structure is made of layered leather.

The support structure 18 is also provided with a slot 24 through which the strap passes to allow the support structure 18 to be engaged with the strap 12 in the desired position. The slot 24 is provided with a means to grip the strap 12 and hold the support structure 18 in the desired position in the engagement position of the support structure 18. When the support structure 18 is in the unengaged or movable position the means to grip the strap 12 is relaxed so the support structure 18 may slide upon the strap 12 until it reaches the desired position.

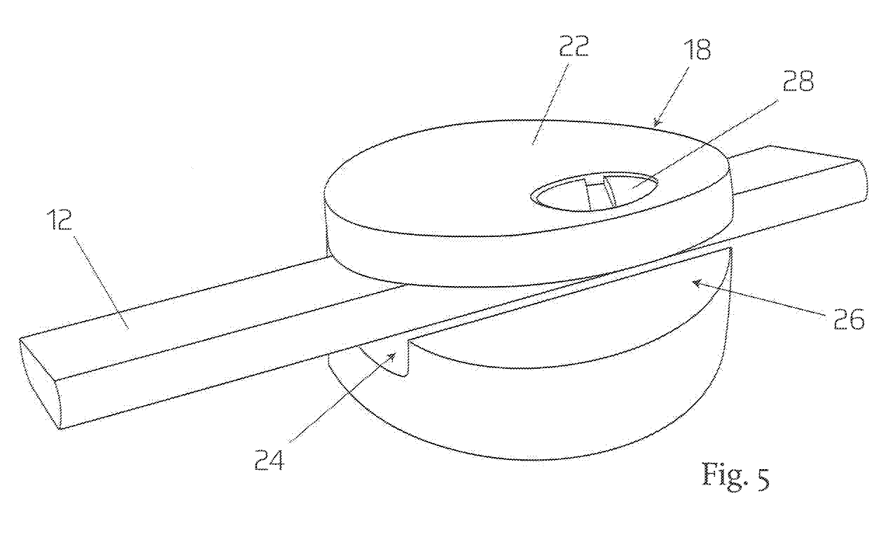

As illustrated in FIGS. 3 to 5, the preferred embodiment of the support structure 18 is provided with a gap 26 on one side of the slot 24 such that the strap 12 may be inserted into the gap 26 until it lies within the slot 24. Once the strap 12 is in the proper position in the slot 24, a fastening means such as screw 28 is inserted through an opening 30 in the top of the support structure 18 above the gap 26 to engage a screw hole 32 provided in the bottom of the support structure 18 below the gap 26. When the screw 28 is tightened down, the gap 26 is closed and the top surface of the slot 24 engages and holds the strap 12 once the support structure 18 is located in the desired position.

While a preferred embodiment of the present invention has been described above and illustrated in the drawings, it will be appreciated by those skilled in the art that variations of the embodiment may be made without departing from the scope of invention. For example while the preferred embodiment of the support structure illustrated in the drawings has a flat top and bottom surface, other shapes of the surface such as a convex surface may be provided.

Another variation relates to the means to grip the strap and hold the support structure in the desired position in the engagement position of the support structure. While the preferred embodiment utilizes the screw to tighten down the top surface of the slot to engage the strap, an alternative would be to merely provide the slot through the support structure with no gap and provide a means to clamp down on the top of the strap when the support structure is in the engagement position. Such a means could include a screw that when tightened down engages the surface of the strap to hold the support structure in position. Alternatively, the top surface of the slot may be provided with a biasing means which may be biased to engage the top of the strap when in the engagement position and be released when it is desired to move the support structure. One example of a biasing means would be a flexible bar in the top of the slot and a screw which could be tightened down to move the flexible bar into engagement with the top surface of the strap. The slot may also be provided with a coating of a material to increase the friction of the strap when contained in the slot in the engaged position. One example of such a material would be beeswax, although those of skill in the art will be aware of other materials which would also be suitable.

The scope of the invention should not be limited by the preferred embodiments set forth in the examples, but should be given the broadest interpretation consistent with the description as a whole.

1. A support system for use with a carrying strap comprising:
at least two support structures;
each support structure having an opening for receiving said carrying strap and an engagement mechanism for securing said support structure to a desired location on said carrying strap; and wherein the support structures are spaced from each other along a length of the carrying strap.

2. A support system for use with a carrying strap as claimed in claim 1 wherein said support structures are shaped to distribute forces over a small area.

3. A support system as claimed in claim 2 wherein each support structure is cylindrical in shape.

4. A support system as claimed in claim 3 wherein each support structure is made of a molded material.

5. A support system as claimed in claim 4 wherein each support structure further includes a slot around a partial perimeter of the support structure, said slot being in communication with the opening such that a carrying strap could be passed through the slot and into the opening.

6. A support system as claimed in claim 5 wherein the engagement mechanism is a screw.

7. A support system as claimed in claim 2 wherein said support structures are positioned on said carrying strap such that when the strap is in use, the support structures are positioned to correspond to the location of major muscles of the neck.

8. A support system as claimed in claim 7 wherein said support structures are positioned on said carrying strap such that when the strap is in use, the support structures are positioned to correspond to the location of the trapezius muscles.

9. A support system as claimed in claim 2 wherein said support structures are positioned on said carrying strap such that when the strap is in use, the support structures are positioned over major muscles of the shoulder.

10. A carrying apparatus comprising
an elongate strap;
at least two support structures;
each support structure being coupled to the elongate strap in a spaced apart manner along the length of the elongate strap.

11. A carrying apparatus as claimed in claim 10 wherein each support structure is moveable along the length of the elongate strap.

12. A carrying apparatus as claimed in claim 11 wherein said support structures are shaped to distribute forces over a small area.

13. A carrying apparatus as claimed in claim 11 wherein each support structure is cylindrical in shape.

14. A carrying apparatus as claimed in claim 14 wherein each support structure is made of a molded material.

15. A carrying apparatus as claimed in claim 14 wherein each support structure has an opening for receiving said elongate strap and an engagement mechanism for securing said support structure to a desired location on said carrying strap; and wherein the support structures are spaced from each other along a length of the elongate strap.

16. A carrying apparatus as claimed in claim 15 wherein each support structure further includes a slot around a partial perimeter of the support structure, said slot being in communication with the opening such that a carrying strap could be passed through the slot and into the opening.

17. A carrying apparatus as claimed in claim 16 wherein the engagement mechanism is a screw.

18. A carrying apparatus as claimed in claim 12 wherein said support structures are positioned on said carrying strap such that when the strap is in use, the support structures are positioned to correspond to the location of major muscles of the neck.

19. A carrying apparatus as claimed in claim 18 wherein said support structures are positioned on said carrying strap such that when the strap is in use, the support structures are positioned to correspond to the location of the trapezius muscles.

20. A carrying apparatus as claimed in claim 12 wherein said support structures are positioned on said carrying strap such that when the strap is in use, the support structures are positioned over major muscles of the shoulder.
